(19) United States
(12) Patent Application Publication
(10) Pub. No.: US 2010/0005593 A1
(43) Pub. Date: Jan. 14, 2010

(54) Lightweight Roll-Up Drag Litter

(76) Inventors: F. Bowling, Ft. Bragg, NC (US); Ross Johnson, Anderson, SC (US)

Correspondence Address: CAHN & SAMUELS LLP, 1100 17th STREET NW, SUITE 401, WASHINGTON, DC, 20036, US

(21) Appl. No.: 12/376,047

(22) PCT Filed: Aug. 6, 2007
(86) PCT No.: PCT/US07/75245

§ 371 Date: Feb. 2, 2009

Related U.S. Application Data
(60) Provisional application No. 60/821,568, filed on Aug. 5, 2006.

(51) Int. Cl. A61G 1/013; A61G 1/048

(52) U.S. Cl. 5/627; 5/628

(57) ABSTRACT

A flexible, portable light-weight drag litter is disclosed capable of being compactly rolled for transportation and storage, having a generally planar base dimensioned to underlie a reclining individual's head, torso, legs, and feet. A torso harness is attached to the base along with groin and leg connectors are attached to the base. A dragline is attached to a head end portion of the base. When a user tugs on the dragline, the base creates a concave surface that supports and protects the patient's head.

### I. TECHNICAL FIELD

This invention relates to devices for transporting injured persons. More particularly, this invention relates to improvements to traditional roll-up portable drag litters/stretchers.

### II. BACKGROUND ART

Traditionally, portable litters/stretchers are constructed for durability, rigidity and containment of the patient. These characteristics allow the litter to be used in environments such as lifting an individual by wench or airlift, for example, a hiker after a mountain climbing fall, a homeowner from a flooded neighborhood, or a soldier from the battlefield. However, these same characteristics also cause the litter to be bulky and weighty, and can also cause delays in lifesaving extraction.

Traditional portable stretchers are made of heavy-duty material to protect the injured person from contact with the ground and other objects during extraction. Heavier, thicker, and wider construction of the litter base keeps the individual from bruising or sustaining additional minor injuries from terrain over which he or she might be dragged. The use of heavier materials also keeps the patient rigid, better supported, and provides a certain amount of splinting. However, the weight and bulk of typical portable stretchers can be a burden to soldiers carrying the litter on their person.

Some portable stretchers have side and bottom flaps which extend from the base. While useful for some applications, the flaps take time to engage, and they can interfere with speedy extraction and medical treatment. For example, foot flaps are unnecessary in most manual-lifting circumstances in which a drag litter is used. However, most roll-up litters/stretchers are provided with foot flaps regardless of whether they are designed for airlifting thereby adding additional bulk and weight to the litter.

Flaps that cover an injured soldier's arms restricts his or her ability to fire a gun or otherwise assist in the evacuation. Flaps covering the soldier's body also can delay a medic's assessment of the soldier's condition—they typically must be removed to gain access to the wounded soldier for medical treatment.

Some stretchers use heavy and complicated equipment. For example, a half-body stretcher provides protection only to the top half of the individual and requires an additional half-body stretcher to secure the lower half of the patient's body. The second half-body stretcher must be carried on the back of a second soldier, causing delays in deployment and possible deficiency if a second half-body stretcher is not available. Some stretchers use large durable buckles or wide heavy straps to retain the patient. The large bulk and weight of traditional portable stretchers/litters sometimes require separate bags for storage and transport.

While these devices might be useful in some scenarios to securely encase a patient prior to, for example, vertical movement (airlift), they add weight and bulk to the stretcher, making it harder to carry on backpacks in a mobile military unit. Weight and bulk are not desirable characteristics in certain circumstances. For example, army soldiers and frontline medics are generally more intent on quick extraction than keeping a wounded soldier fully splinted or protected from minor bruises and cuts. Traditional devices require time to deploy—time being an expensive luxury for those engaged in an emergency situation.

Some stretchers have been designed to compact into a cylindrical roll for storage and transportation. This configuration allows soldiers to carry the litter, on a backpack for example. However, common designs of the roll-up stretcher are heavy and bulky. They are typically made of thick materials, some measuring as much as 0.100 inches thick or more, which allows the litter to roll only to a seven (7) inch diameter. These roll-up litters are also wide in dimension, 2 feet (24 inches) or more, and as long as eight (8) feet in length, some having additional length to create a flap for covering the patient's feet. While larger dimensions add unnecessary weight and bulk to the stretcher, these width characteristics also make lifting and transportation difficult. For example, many stretchers have several handles for manual lifting. The handles are typically attached to the outer periphery of the base or side flaps of the stretcher. In the case of side flaps, the edges of the flaps partially or fully wrap around the individual, causing the handles to become located toward the top centerline of the individual. From this location, lifting and transportation are difficult. Roll-up stretchers measuring as much as two (2) feet in width also have the problem of wrapping too far around the individual's side. This also forces those carrying the litter to use additional leverage, making lifting and extraction more difficult.

Most portable litters include a dragline, typically attached to the head end of the stretcher. Pulling on the dragline allows even a single person to drag the stretcher along the ground. However, draglines are not usually contained in any way and are typically left dangling during deployment of the stretcher. A dragline is not always necessary, for example, during manual lifting using handles. A loose, dangling dragline can be a nuisance, in many instances being unnecessary, becoming easily entangled, and interfering with the securing and extraction of the wounded soldier.

Notwithstanding the usefulness of the above-described structures, a need still exists for a narrow, lightweight, convenient, easily deployable portable drag litter.

### III. DISCLOSURE OF THE INVENTION

It is an object of the invention to provide a litter that can be easily slid along terrain yet prevents slippage of the patient.

It is another object of the invention to provide a litter that can be readily attached to a medic's bag or backpack.

It is still a further object of the invention to provide a litter that protects the adequately protects patient's sides during transport.

It is yet another object of the invention to provide a litter that includes multiple grab points for passing a packaged patient through confined and tight spaces.

In one embodiment of the invention a portable litter includes a generally narrow rectangular planar base dimensioned to underlie the head, torso, and legs of the patient in a reclined position, preferably constructed of a acrylic-PVC alloy no thicker than 0.030 inches and preferably measuring no longer than seven (7) feet and no wider than eighteen (18) inches. The base is adapted to be rolled into a compact cylinder, the roll preferably measuring no wider in diameter than five (5) inches. The litter includes a harness adapted to secure the patient's upper torso to the base by way of connectors passing across the patient's waist and chest and attaching to the right and left periphery of the base adjacent to the waist and chest. The harness also includes left and right side connectors attaching to the head end of the base and to either the waist connector, the chest connector, or both. The portable litter also includes right and left groin connectors which wrap around the patient's upper legs and attach to the left and right periphery of the base adjacent to the patient's groin. The litter further includes a connector passing across the patient's lower legs and similarly attaching to the base adjacent to the lower legs.

In other embodiments, the litter includes a dragline or a handle, or both, affixed to the head end of the base. In further embodiments, the dragline includes an envelope adapted to retain a majority of the dragline when it is not deployed. The envelope can removably attach to the underside of the head end of the base when the dragline is not deployed, and can wrap around a portion of the deployed dragline to provide a gripping surface.

In a further embodiment, the dragline or handle is affixed to the base closer toward the centerline than the attachment point of the left and right side connectors of the harness. When the handle or dragline is used in conjunction with the side connectors, the base forms a concave surface supporting and protecting the patient's head.

In the following enabling description, reference is made to the accompanying drawings which are shown by way of illustration of the specific embodiments in which the invention may be practiced. In the following embodiments the apparatus and methods should become evident to a person of ordinary skill in the art and in sufficient detail to enable those skilled in the art to practice the invention. It is to be understood that other embodiments may be used and that structural changes based on presently known structural and/or functional equivalents may be made without departing from the scope of the invention.

### IV. BRIEF DESCRIPTION OF THE DRAWINGS

FIG. 1. is a side/top perspective view of an embodiment of the invention.

FIG. 2. is a top view of an embodiment of the invention.

FIG. 3. is a side/top perspective view of the head end of an embodiment of the invention.

FIG. 4. is a view of the underside of an embodiment of the invention.

FIG. 5. is a side perspective view of an embodiment of the invention in a rolled-up configuration.

FIG. 6. is a view of an embodiment of the dragline envelope in an open configuration.

FIG. 7. is a top/side perspective view of an embodiment of the envelope in a partially closed configuration.

FIG. 8A is a top view of a keeper buckle.

FIG. 8B illustrates the keeper buckle of FIG. 8A securing a strap in accordance with an embodiment of the invention.

### V. DETAILED DESCRIPTION OF THE DRAWINGS

As used herein, “substantially,” “generally,” “relatively” and other words of degree are relative modifiers intended to indicate permissible variation from the characteristic so modified. They are not intended to be limited to the absolute value or characteristic which they modify, but rather possessing more of the physical or functional characteristic than its opposite, and preferably approaching or approximating such a physical or functional characteristic.

As used herein, the phrase “hook/pile fastener” refers to a fastening device comprising a surface of minute hooks that fastens to a corresponding strip with a surface of uncut pile (for example, that sold under the trade name VELCRO® by Velcro Industries B.V.).

As used herein, the phrase “ring buckle” refers to a device consisting of one or two generally D-shaped or O-shaped rings held together at one end and through which a strap passes at the other end, the strap simply passing through, or looping around one or both rings to form a secure attachment.

The terms “stretcher” and “litter” are used interchangeably herein.

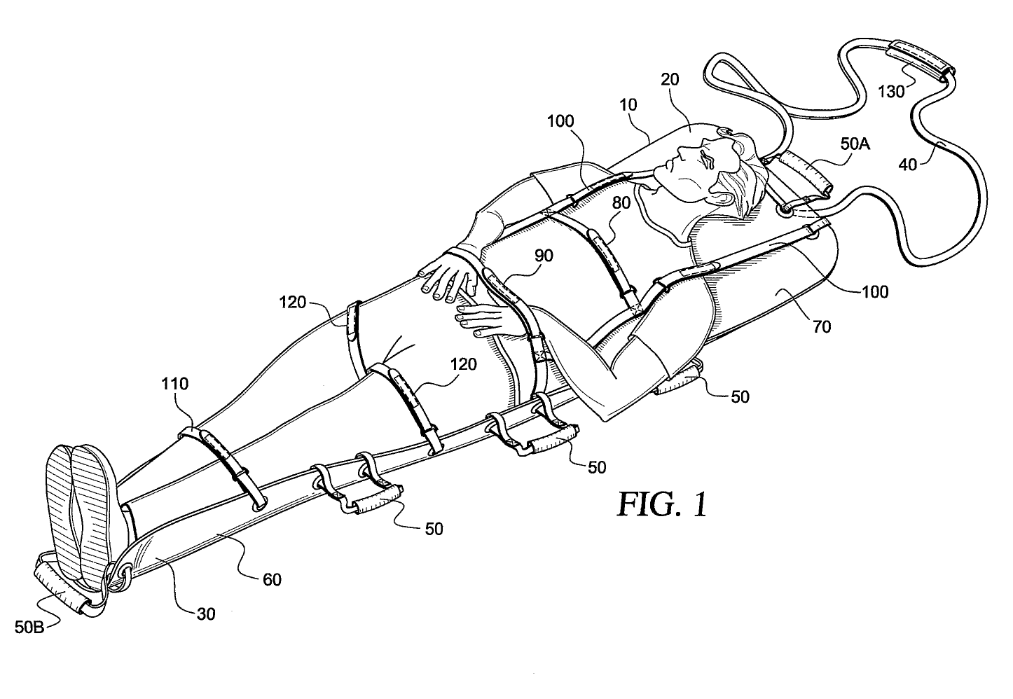

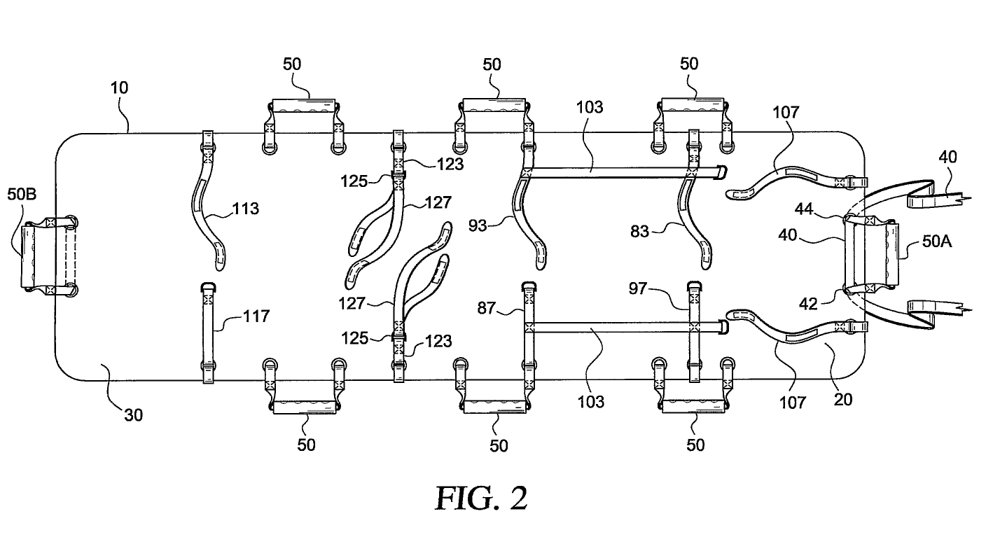

The present invention is generally directed to a portable litter for transporting a human patient. A portable litter in accordance with one embodiment of the invention, illustrated in FIG. 1, includes a generally planar base 10 dimensioned to underlie the head, torso and legs of a patient in a reclined position. The litter has a torso harness and several straps affixed to the periphery of the base 10 to keep the patient retained on the base 10. The torso harness includes two side connectors 100 passing along the sides of the patient's upper torso and a waist connector 90 affixed to side connectors 100 and disposed generally perpendicular to side connectors 100. Each side connector 100 includes a lower strap 103 and an upper strap 107 as depicted in FIG. 2. Lower straps 103 are affixed to the waist connector 90 at a lower end portion and to a chest connector 80 at an upper end portion. The upper strap 107 is affixed to base 10 near the corners of the head end 20 of the base 10. A dragline 40 and handle 50A are also attached to the head end 20 of the base 10. In the illustrated embodiment, dragline 40 and handle 50A are attached to head end 20 of base 10 between the point where the upper straps 107 attach to the base 10. However, straps 107 may be attached to base 10 anywhere along head end 20. Preferably, when the handle 50A or dragline 40 is used in conjunction with the upper straps 107, the base 10 forms a concave surface supporting and protecting the patient's head.

In keeping with the invention, the base 10 is generally rectangular. The base 10 is preferably about eighteen (18) inches wide, and in those embodiments without a leg flap the base 10 is preferably about seven (7) feet in length. The base 10 is constructed of a light-weight durable material, such as HDPE (high density polyethylene). In other embodiments, base 10 is constructed of an acrylic-PVC composition, for example, that sold under the registered trademark Kydex® by Kleerdex Company LLC of Aiken, S.C. This thin, flexible materials allow the base 10 to somewhat conform to the contours of the patient's body, thereby reducing the amount of movement between the patient and the base 10 and providing a measure of splinting. These materials also allows the base 10 to be rolled into a compact cylinder (see FIG. 5), with a diameter of about five (5) inches or less. These characteristics of narrow, lightweight flexibility make the litter portable and easy to carry.

In many environments, it is desirable for the underside 60 to be smooth to facilitate sliding the litter over the terrain. Conversely, it is desirable for the topside 70 of base 10 to be rough or tacky to impede the patient from sliding off the base 10. Accordingly, for example, underside 60 may have a lower coefficient of friction than topside 70. More particularly, topside 70 may be provided with a haircell finish to increase resistant to patient sliding.

A torso harness and several straps are used to hold the individual onto the base 10 and are affixed to the base 10 along its general periphery. The torso harness includes chest connector 80, waist connector 90 and right and left side connectors 100. In the embodiments illustrated in FIGS. 1, 2, and 3, these connectors 80, 90 and 100 are straps. Chest connector 80 includes a first strap 83 and a second strap 87 each connected to base 10 at respective first ends generally adjacent to the patient's chest. In the deployed configuration, straps 83 and 87 traverse the patient's chest and are attached to each other at respective second ends. Similarly, waist connector 90 includes a first strap 93 and a second strap 97 each connected to the base 10 at respective first ends generally adjacent to the patient's waist. Straps 93 and 97 traverse the patient's waist and are attached to each other at respective second ends. The side connectors 100 each include an upper strap 107 and a lower strap 103. The upper strap 107 is affixed at a first end to the periphery of the base 10 at the head end 20 of the base 10. The lower strap 103 is affixed at a first end to the waist connector 90 and is also affixed near its second end to the chest connector 80. According to the invention, the lower strap 103 of the side connector 100 could also attach to only one of waist connector 90 and chest connector 80. The upper strap 107 and lower strap 103 are attached to each other at respective second ends.

The torso harness retains the patient's upper torso to the litter base 10 and minimizes movement of the upper torso. In the embodiments illustrated in FIGS. 1 and 2, the chest connector 80 passes under the patient's armpits restricts the individual from sliding off the foot end 30 of the base 10. Because the side connectors 100 are attached to the head end 20 of the base 10, they restrict the patient from sliding off the base 10 in the direction of head end 20. Of course, consistent with the invention, the torso harness may include several configurations. For example, the torso harness may be permanently affixed at only the head end 20 or the right or left side of the base 10, or a combination of the head end 20 and either the right or left sides, and removably attachable at the other locations. The torso harness can also include or be made of devices or materials other than straps, for example a canvas jacket that covers as much of the patient as possible may be useful for cold weather applications. Also, the waist, chest and side connectors can be integrally formed.

In the illustrated embodiments, waist connector 90, chest connector 80 and side connectors 100 are permanently affixed to the base 10 by passing through grommets and stitching respective connectors to themselves. Of course, this connection can be by other means such as a ring buckle attached to the base 10. Also, in the illustrated embodiments the straps are attached to each other by ring buckles and hook/pile fasteners, and the straps are narrow enough that they can be attached by hand tying. Attachment of the straps can also occur by other devices, such as snaps or snap-fit connectors.

According to the invention, the litter also includes left and right groin connectors 120 attached to the left and right sides of the base 10 generally adjacent to the patient's groin. The groin connectors 120 pass around the patient's upper legs near the crotch, and thereby secure the upper legs and lower abdomen to the base 10. The groin connector 120 also helps to prevent the patient from sliding off the foot end 30 of the base 10. In the embodiments illustrated in FIGS. 1 and 2, each groin connector 120 includes a first strap 123 affixed at a first end to the base 10 and at a second end to a ring buckle. A second strap 127 engages ring buckle 125 and includes first and second ends that may be removably attached to each other by, for example, hook and pile fasteners such that groin connectors 120 snugly cinch the patient's upper thigh area.

Groin connectors 120 can also take other configurations such as a single long strap threaded through a grommet or a ring buckle affixed to the base 10 with the strap stitched or hand tied or otherwise attached to itself. As one skilled in the art can appreciate, the connection between the first and second ends of the second strap 127 can also occur in any number of ways, similar to the discussion above regarding waist connector 90, chest connector 80 and side connectors 100.

The litter further includes a leg connector 110. In the embodiments illustrated in FIGS. 1 and 2, leg connector 110 includes a first strap 113 and a second strap 117 at their first ends connected to the base 10 generally adjacent to the patient's lower legs. The leg connector 110 straps 113 117 pass across the patient's lower legs and are removably attachable at their second ends. The leg connector 110 retains the patient's lower legs on the litter base 10 and prevents movement of the legs.

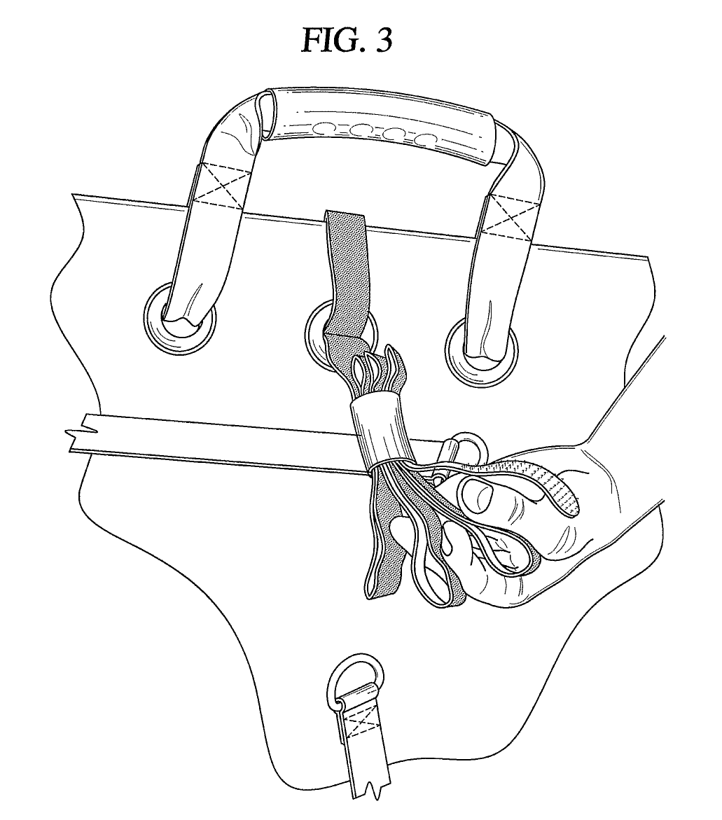

When the litter is not in use, it is beneficial to store the straps, particularly chest strap 93 and waist strap 83, in an unobtrusive manner. Accordingly, strap retainers 200 are provided to secure straps in an S-fold or z-fold configuration, as illustrated in FIG. 3. Strap retainers 200 help prevent strap tangles and twists which can be a significant problem when attempting to deploy the litter in dark conditions.

Some embodiments of the portable litter include a dragline 40 at the head end 20 of the base 10. In the illustrated embodiments the dragline 40 is a strap which is threaded from the underside 60 of the base 10 through two grommets 42, 44 and passes between grommets 42, 44 on the topside 70. The dragline 40 is used to pull the litter and the patient over the ground, and can be operated by a single individual.

In certain embodiments the portable litter includes a plurality of handles 50, which are affixed at various locations along the periphery of the base 10. For example, in the embodiment illustrated in FIGS. 1 and 2, there are handles 50 on the right and left side of the base 10, between the leg connector 110 and the groin connectors 120, near the waist connector 90, and adjacent to the chest connector 80. A handle 50B is also located near the centerline at the foot end 30 of the base. This handle 50B allows lifting of the patient's feet and direct support of the foot end 30 of the base 10 during transportation, thereby restricting the patient from sliding off. Another handle 50A is located at the head end 20 of the base 10. In the illustrated embodiments, the handle 50A uses the same grommets as the dragline 40, which is also located at the head end 20 of the base 10. Having both a handle 50A and a dragline 40 available on the litter facilitates lifting and dragging the patient.

In the illustrated embodiments, the handles 50 are straps which are affixed to the base 10 and are surrounded by a rigidly flexible, cylindrical, and slightly curved grip member 140. Grip member 140 is preferably made of a lightweight plastic or rubber material, but can also include other materials such as canvas. Grip member 140 helps prevent the straps of handle 50, 50A and 50B from cutting into the carrier's hand. The handles 50, 50A and 50B can be affixed to the base 10 in a variety of ways. For example, the strap of the handle 50B at the foot end 30 of the base 10, illustrated in FIG. 1, is threaded from the topside 70 of the base 10 through two grommets and passes between the grommets on the underside 60. On other handles 50, such as those between the leg connectors 110 and groin connectors 120, each end passes through a grommet on the base 10 and is then stitched to itself. The handles 50 near the waist connectors 90 use the same grommets used by the waist connectors 90, while the handles 50 adjacent to the chest connectors 80 employ grommets independent of, and on either side of the grommets used by the chest connectors 80.

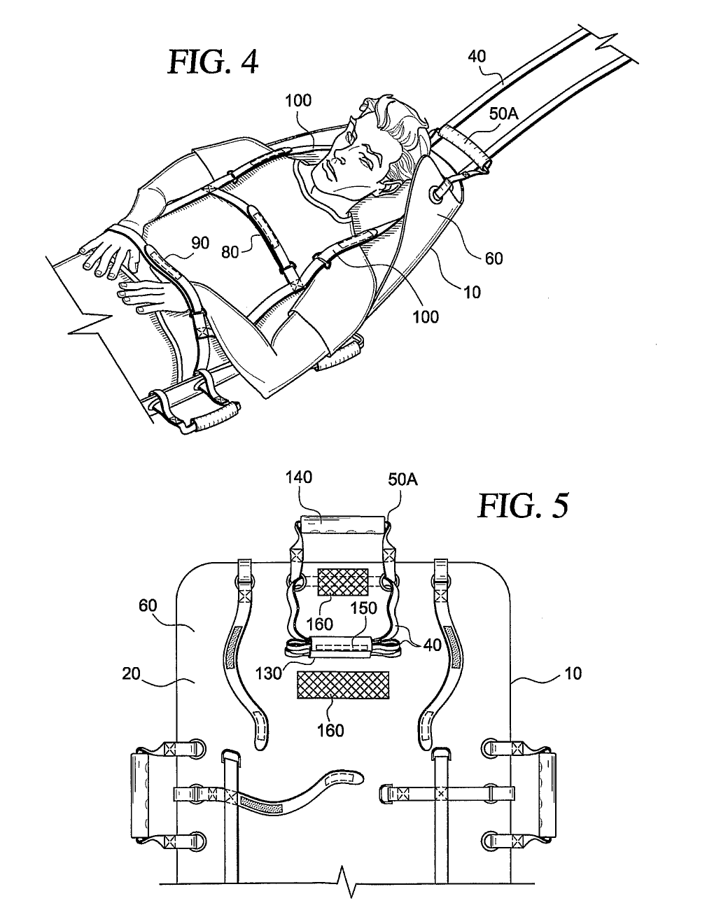

As noted above, a handle 50A is located at the head end 20 of the base 10. In the embodiments illustrated in FIGS. 1 and 2, this handle 50A uses the same grommets as the dragline 40. As also discussed above, the side connectors 100 are also affixed to the head end 20 of the base 10. In the embodiments illustrated in FIGS. 1, 2 and 3, the side connectors 100 use different grommets than the handle 50A and the dragline 40. The grommets used by the handle 50A and dragline 40 are closer to the centerline of the base 10 than the grommets used by the side connectors 100. In these embodiments, when the handle 50A or the dragline 40 are pulled taut in conjunction with use of the side connectors 100, the head end 20 of the base 10 forms a concave surface, as illustrated in FIG. 4, around the patient's head. This provides an element of support and splinting for the head. Also, the corners of head end 20 partially cover the patient's head and face, providing protection from foreign objects and rough terrain.

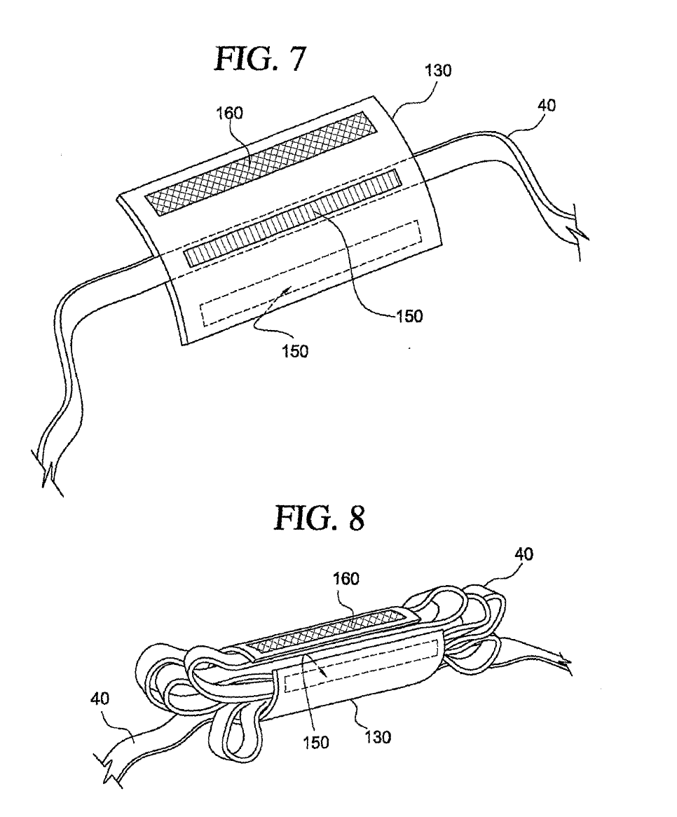

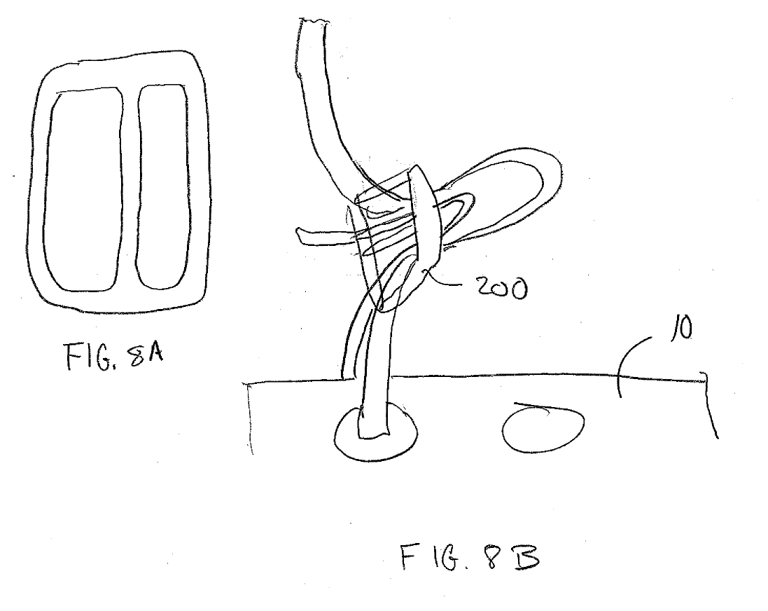

In the illustrated embodiments, an envelope 130 is attached to the dragline 40 and is adapted to removably retain a majority of the dragline 40 when it is not deployed. Prior to deployment, the dragline 40 is bundled together and enclosed by the envelope 130 which wraps around the dragline 40 as depicted in FIG. 5, and thereby keeps dragline 40 out of the way while the patient is secured or first aid is rendered. In the embodiment illustrated in FIG. 7, the envelope 130 is a generally planar cut of material that is attached, either fixedly or removably, to dragline 40. For example, in the embodiment depicted in FIG. 7, envelope 130 is attached to dragline 40, e.g., by stitching lengthwise along the middle of the envelope 130. Envelope 130 includes a closure mechanism having a hook portion 150 and a pile portion 160 of a hook/pile fastener disposed along the edges of the envelope 130 substantially parallel to the dragline 40. The hook portion 150 and pile portion 160 are on opposite surfaces of the envelope 130, allowing the envelope 130 to roll into a generally cylindrical encasement around the bundled dragline 40 (see FIG. 8) and removably close by way of the hook/pile fastener. Of course, snaps or other connection devices can be used to close the envelope 130, and the envelope 130 can take other forms consistent with its function. Once the dragline 40 is deployed, as illustrated in FIG. 7, the envelope 130 wraps around that portion of the unfurled dragline 40 affixed to the envelope 130, and thereby provides a surface by which an individual can easily grip the dragline 140 (see FIG. 1).

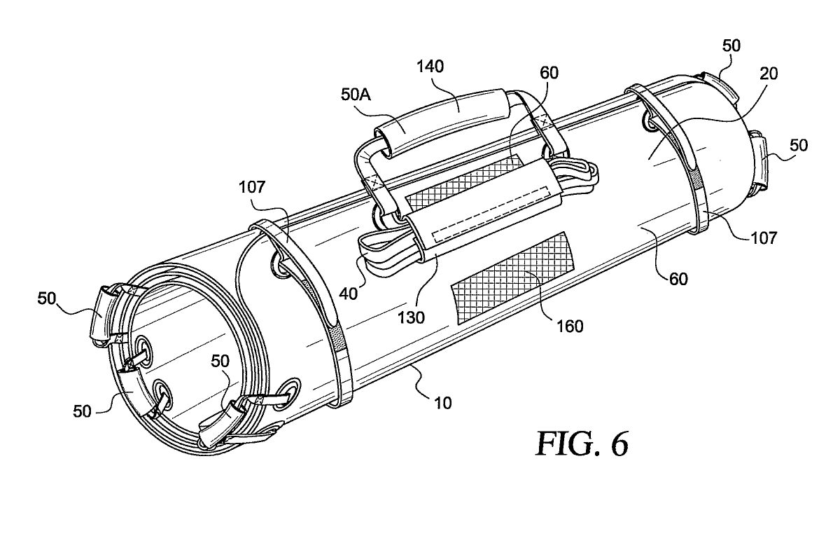

In the embodiments illustrated in FIGS. 6 and 7, the envelope 130 removably attaches to the underside 60 of the head end 20 of the base 10. As also illustrated in FIG. 5, a hook portion 150 of a hook/pile fastener is affixed to the envelope 130 and removably attaches to a pile portion 160 affixed to the underside 60 of the base 10. Of course, snaps or other connection devices can be used to attach the envelope 130 to the base 10, either permanently or removably. The envelope 130 can also take other forms such as a string-tie or a small strap with a hook/pile fastener affixed to the base 10. In this way, the dragline 40 is contained and kept out of the way until it is ready, if ever, to be deployed. For example, a user may decline to employ dragline 40 in favor of handle 50A. In such a scenario, envelope 130 houses dragline 40 such that it does not impede the user.

In keeping with an aspect of the invention, illustrated in FIG. 6, is a device for retaining the portable litter in a rolled configuration. When the litter is in the rolled configuration, the upper strap 107 is exposed. As illustrated in FIG. 6, the upper strap 107 can be wrapped around the rolled litter and connect to itself. In the illustrated embodiment, the connection is by way of a hook/pile fastener, however, the upper strap 107 can be connected to itself by other means consistent with its functions. Thus upper strap 107 functions both as a device for restraining the patient from axial slippage and as a device for maintaining the litter in the rolled configuration.

In accordance with an aspect of the invention, instead of securing the straps and handles to base 10 by stitching, one or more straps and handles may be removably secured to base 10 through corresponding grommets by, e.g., keeper buckles 200, as illustrated in FIGS. 8A and 8B. By removably attaching the straps to base 10, the user can easily replace, modify or remove the straps in the field by hand. Accordingly, for users who prefer different strap connector mechanisms, e.g., side release buckle closure system verses Velcro®, those users can readily remove the straps and install new straps of their choosing.

### VI. INDUSTRIAL APPLICABILITY

The above-described invention is useful for transporting wounded patients, particularly in emergency or battlefield environments.

Given the foregoing, it should be apparent that the specifically described embodiments are illustrative and not intended to be limiting. Furthermore, variations and modifications to the invention should now be apparent to a person having ordinary skill in the art. These variations and modifications are intended to fall within the scope and spirit of the invention as defined by the following claims.

1. A portable litter for transporting a human patient comprising:
A generally narrow rectangular planar base including a topside and an underside, a head end and a foot end, dimensioned to underlie the head, torso, and legs of the patient in a reclined position,
A torso harness adapted to secure the patient's upper torso to said base including:
a waist connector adapted to pass across the patient's waist and attach to the right and left general periphery of said base adjacent to the patient's waist,
a chest connector adapted to pass across the patient's chest and attach to the right and left general periphery of said base adjacent to the patient's chest, and
left and right side connectors adapted to attach to the general periphery of said head end of said base, and to at least one of said waist connector and said chest connector,
A right and left groin strap adapted to wrap around the patient's upper leg and attach to the left and right general periphery of said base adjacent to the patient's groin, and
A leg connector adapted to pass across the patient's lower legs and attach to the general periphery of said base adjacent to the patient's lower legs.

2-4. (canceled)

5. The portable litter of claim 1 wherein said underside of said base has a first coefficient of friction and said topside of said base has a second coefficient of friction wherein the first coefficient of friction is less than the second coefficient of friction.

6. The portable litter of claim 1 wherein said base is adapted to be rolled into a generally cylindrical configuration no wider than five (5) inches.

7. The portable litter of claim 1 also including a dragline affixed to the head end of said base.

8. The portable litter of claim 7 also including an envelope adapted to removably retain a majority of said dragline when said dragline is not deployed.

9. The portable litter of claim 8 wherein said envelope is also adapted to wrap around said dragline to provide a gripping surface.

10. The portable litter of claim 9 wherein said dragline is removably attachable to said underside of said head end of said base.

11. The portable litter of claim 10 wherein said dragline is affixed closer to said centerline of said base than said left and right side connectors, and wherein when said dragline is used in conjunction with said left and right side connectors, said base forms a concave surface supporting and protecting the head of the patient.

12. The portable litter of claim 1 including at least one handle affixed to the periphery of said base.

13-14. (canceled)

15. The portable litter of claim 1 wherein said chest connector includes a first and second strap being affixed at a first end to said base and being attachable at their second ends.

16. The portable litter of claim 1 wherein said waist connector includes a first and second strap being affixed at a first end to said base and being attachable at their second ends.

17. The portable litter of claim 1 wherein said left and right side connectors each include an upper strap being affixed at a first end to said base and a lower strap being affixed at a first end to at least one of said waist connector and said chest connector, said upper strap and said lower strap being attachable at their second ends.

18. The portable litter of claim 1 wherein the underside of said base has a smooth surface and the topside of said base has a rough surface.

19. The portable litter of claim 1 wherein said groin straps include a first strap affixed to said base at a first end and a second strap attached to a second end of said first strap and adapted to wrap around the patient's upper leg.

20. The portable litter of claim 1 wherein at least one of said torso harness, said right and left groin straps, and said leg connector are removably attached to said base.

21. The portable litter of claim 8, wherein said envelope is fixedly attached to said dragline by stitching lengthwise along a middle of said envelope.

22. The portable litter of claim 8, wherein said envelope is removably attachable to said underside of said head end of said base.

23. The portable litter of claim 8, wherein said envelope comprises a closure mechanism comprising a hook portion and a pile portion, said closure mechanism disposed along edges of said envelope and parallel to said dragline.

24. The portable litter of claim 23, wherein said hook portion and said pile portion are on opposite surfaces of said envelope to allow said envelope to roll into a cylindrical encasement around said dragline when said dragline is in a bundled configuration.

25. The portable litter of claim 17, wherein said upper strap wraps around said base when said base is in a rolled configuration, wherein said upper strap connects to itself to maintain said base in said rolled configuration.
